(19) United States
(12) Patent Application Publication
(10) Pub. No.: US 2025/0005963 A1
(43) Pub. Date: Jan. 2, 2025

(54) AUGMENTED REALITY GLASSES FOR IRIS-RECOGNITION-BASED AUTHENTICATION

(71) Applicant: AMC Corporation, Sammamish, WA (US)

(72) Inventor: Eric Johnsen, Sunnyvale, CA (US)

(73) Assignee: AMC Corporation, Sammamish, WA (US)

(21) Appl. No.: 18/604,244

(22) Filed: Mar. 13, 2024

Related U.S. Application Data
(60) Provisional application No. 63/524,504, filed on Jun. 30, 2023.

(51) Int. Cl. G06V 40/18; G02B 27/01; G02C 11/00; G06F 21/32; G06V 10/774; G06V 40/19

(52) U.S. Cl. CPC G06V 40/197; G02B 27/0172; G02C 11/10; G06F 21/32; G06V 10/774; G06V 40/19; G06V 40/193; G02B 2027/0138; G02B 2027/014; G02B 2027/0178

(57) ABSTRACT

One embodiment of this disclosure can provide a pair of augmented reality (AR) glasses. The AR glasses can include a pair of lenses, with at least a portion of a lens of the AR glasses functioning as a see-through display; a frame comprising rims surrounding the lenses; a rear-facing camera embedded in a rim and configured to capture) images of a corresponding eye of a user while the user is wearing the AR glasses; and a user-authentication system to authenticate the user based on the captured eye images. The result of the user authentication is displayed on the see-through display.

### RELATED APPLICATIONS

This disclosure claims the benefit of U.S. Provisional Application No. 63/524,504, Attorney Docket No. AMC23-1001PSP, entitled “IRIS-DETECTION-BASED AUTHENTICATION ON AUGMENTED REALITY (AR) GLASSES,” by inventors Eric Johnsen and Zhengming Fu, filed 30 Jun. 2023, the disclosure of which is incorporated herein by reference in its entirety for all purposes.

### BACKGROUND

### Field

The disclosed embodiments generally relate to augmented reality (AR) technologies. More specifically, the disclosed embodiments relate to using AR glasses for iris-recognition-based user authentication.

### Related Art

Wearable devices (also referred to as wearables) have gained popularity in recent years due to their versatility and the ability to integrate cutting-edge technologies seamlessly into daily life. Among the various types of wearable devices, smartglasses have the potential to revolutionize the way humans interact with digital information and their surroundings because they are often placed right in front of users' eyes. Typical smartglasses can use AR technologies to overlay digital information, visuals, and data onto users' real-world view and are often referred to as AR-enabled glasses or simply AR glasses. Advances in technologies have enabled compact and lightweight designs of AR glasses that can find applications in many fields.

### SUMMARY

One embodiment of this disclosure can provide a pair of augmented reality (AR) glasses. The AR glasses can include a pair of lenses, with at least a portion of a lens of the AR glasses functioning as a see-through display; a frame comprising rims surrounding the lenses; a rear-facing camera embedded in a rim and configured to capture images of a corresponding eye of a user while the user is wearing the AR glasses; and a user-authentication system to authenticate the user based on the captured eye images. The result of the user authentication is displayed on the see-through display.

In a variation on this embodiment, the rear-facing camera is embedded at a bottom portion of the rim.

In a variation on this embodiment, the rear-facing camera is embedded at a

top portion of the rim.

In a variation on this embodiment, the AR glasses can further include a second rear-facing camera embedded in a second rim.

In a variation on this embodiment, the user-authentication system can further include an image-processing unit to process the captured images and a feature-extraction unit to extract iris features from the captured images.

In a further variation, while processing a captured image, the image-processing unit can be configured to detect and segment an iris portion within the captured image.

In a further variation, the user-authentication system can further include a machine-learning unit that can be configured to generate the user-authentication result by using the extracted iris features as input of a pre-trained machine-learning model.

In a further variation, the AR glasses can further include a communication unit configured to communicate the user-authentication result to a controller of a restricted resource to facilitate the user in accessing the restricted resource.

In a further variation, the communication unit can include one or more of: a Wi-Fi communication sub-unit; a cellular communication sub-unit; a Bluetooth communication sub-unit; and an Internet of Things (IOT) communication sub-unit.

In a further variation, the rear-facing camera can be configured to continuously or intermittently capture images of the corresponding eye of the user subsequent to authenticating the user, the captured images to be used in further training of the machine-learning model.

One embodiment of this disclosure can provide a method for authenticating a user. The method can include capturing, by a rear-facing camera embedded in a pair of augmented reality (AR) glasses worn by the user, images of an eye of the user; processing the captured images; extracting iris features from the processed images; and inputting the extracted iris features to a pre-trained machine-learning model to generate a user-authentication output.

### DESCRIPTION OF THE FIGURES

FIG. 1 illustrates an exemplary block diagram of an augmented reality (AR)-glasses system, according to one embodiment of the instant application.

FIG. 2 illustrates an exemplary block diagram of the user-interaction unit, according to one embodiment of the instant application.

FIG. 3 illustrates an exemplary block diagram of the communication unit, according to one embodiment of the instant application.

FIG. 4 illustrates an exemplary block diagram of the sensor unit, according to one embodiment of the instant application.

FIG. 5 illustrates an exemplary pair of AR glasses, according to one embodiment of the instant application.

FIG. 6 illustrates an exemplary user-authentication system on a pair of AR glasses, according to one aspect of the instant application.

FIG. 7 presents a flowchart illustrating an exemplary user-authentication operation performed by a pair of AR glasses, according to one embodiment of the instant application.

FIG. 8 illustrates an exemplary computer system that facilitates the user-authentication operation of the AR glasses, according to one embodiment of the instant application.

In the figures, like reference numerals refer to the same figure elements.

### DETAILED DESCRIPTION

### Overview

Embodiments of this disclosure can provide compact and lightweight augmented reality (AR) glasses that can be used for iris-recognition-based user authentication tasks. The AR glasses can include a processing unit and one or more cameras mounted at various locations on the frame (e.g., the bottom or top portion of the lens rim). The cameras can capture images of the user's eye, including the iris. The processing unit can analyze the captured images to perform iris-recognition-based user authentication. Alternatively, the processing unit can extract an iris-feature vector from the iris images, and a high-speed communication unit in the AR glasses can communicate with a cloud server to authenticate the user based on the iris-feature vector. The AR glasses can also include a user-interaction unit for interacting with the user using various mechanisms (e.g., by recognizing the user's hand gestures or tracking the user's head or eye movement).

In this disclosure, the terms “smartglasses,” “AR glasses,” or “AR-enabled glasses” are used interchangeably.

### System Diagram

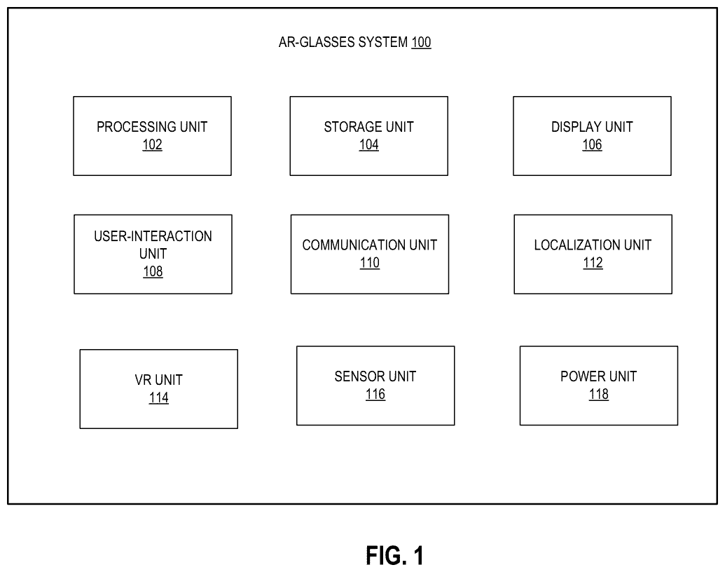

FIG. 1 illustrates an exemplary block diagram of an augmented reality (AR)-glasses system, according to one embodiment of the instant application. AR-glasses system 100 can include a processing unit 102, a storage unit 104, a display unit 106, a user-interaction unit 108, a communication unit 110, a localization unit 112, a virtual reality (VR) unit 114, a sensor unit 116, and a power unit 118. Processing unit 102 can be the brain of AR-glasses system 100 and can include one or more processors for performing various computing tasks. In some embodiments, processing unit 102 can include processors that are optimized for edge computing, which is defined as computing outside the cloud happening at the edge of the network. In one embodiment, processing unit 102 can include a high-speed multi-core processor (e.g., SDM 660 developed by Qualcomm).

Storage unit 104 can include a memory, a solid-state storage device, or both. The memory in storage unit 104 can include a random-access memory (RAM) device, a dynamic random-access memory (DRAM) device, or both. In one embodiment, storage unit 104 can include a RAM device with a capacity of at least 2 GB and a DRAM device with a capacity of at least 64 GB. In addition to onboard storage capacity, storage unit 104 can also include a storage extension slot for plugging in an external storage device (e.g., a Secure Digital (SD) card or a microSD card). In one example, the capacity of the external storage device can be at least 256 GB. Storage unit 104 can store an operating system, which can be executed by the processor(s) in processing unit 102 to provide a number of functions, including collecting various types of input information, processing the input information, and displaying the corresponding output information. In one example, the operating system can be a mobile operating system such as Android.

Display unit 106 can include one or more transmissive displays. In some embodiments, the transmissive displays can be see-through displays and can include one or both lenses of the AR glasses. In further embodiments, each see-through display may include the entire lens or a portion of the lens. The displays can be substantially transparent to allow the user wearing the glasses to view the displayed information along with the surrounding environment. In some embodiments, display unit 106 can use near-eye display technology to display information (e.g., data and graphics) in such a way that the user can perceive the information as being projected at a distance between two and three meters and with a viewing angle of approximately 110 degrees. The resolution of the display can be at least 2K (e.g., 2048×1080 pixels), and the frame rate can be at least 30 frames per second (FPS).

In some embodiments, a see-through display can include a geometrical or arrayed waveguide display, which can use arrayed waveguides to expand or enlarge high-resolution images provided by a microdisplay. In one embodiment, the geometrical waveguide display can include more than one (e.g., two) waveguide layers. When both lenses are used as displays, stereo images can be generated by displaying a slightly different image on each lens to be viewed by each eye. In alternative embodiments, a see-through display can include a holographic waveguide display, where the lenses are made of nano-scale holograms. In some embodiments, the holographic waveguide display in display unit 106 can create 360° holographic 3D images.

In some embodiments, display unit 106 can implement unlimited virtual screen extension, where the region of display can be controlled based on changes in the field of vision (or visual field) of the user. For example, when the user's field of vision changes as the user turns the head or looks away, display unit 106 can change the region of display accordingly such that the region of display can be in the center of the user's field of vision. In one example, display unit 106 can display multiple windows simultaneously in the 360° space surrounding the user's head and can switch between the windows based on the head movement of the user. Alternatively, the user may use hand gestures or a physical controller to switch between the windows. The outcome of the user authentication can be displayed on the see-through display.

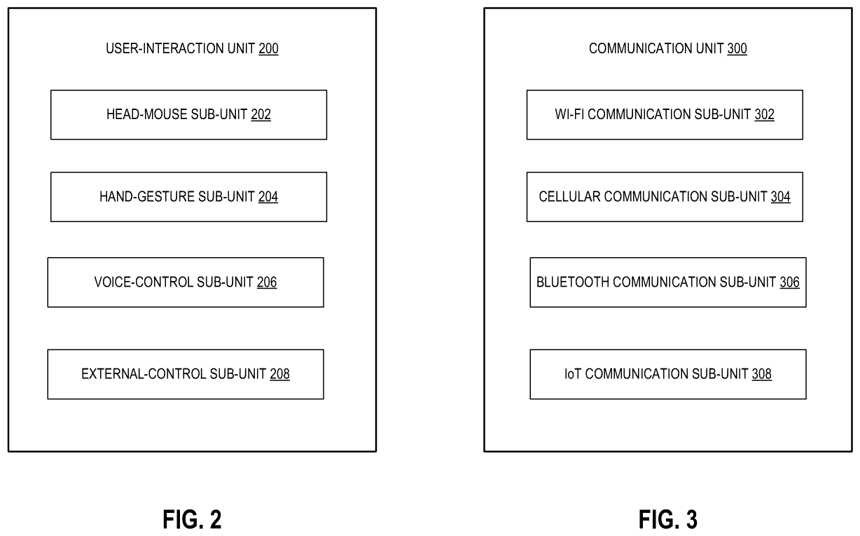

User-interaction unit 108 can include various sub-units for interacting with the user using various user-interaction mechanisms, including but not limited to head/eye or hand gesture tracking, speech recognition, and usage of external controllers. FIG. 2 illustrates an exemplary block diagram of the user-interaction unit, according to one embodiment of the instant application. In FIG. 2, user interaction unit 200 can include a head-mouse sub-unit 202, a hand-gesture sub-unit 204, a voice-control sub-unit 206, and an external-control sub-unit 208.

Head-mouse sub-unit 202 can track the movement of a user's head and translate such movement into mouse pointer movement. For example, the mouse pointer may follow the movement of the head. Move your head to the right, the mouse pointer moves to the right as well. A quick nod can be translated into a mouse clicking. In one embodiment, head-mouse sub-unit 202 may interface with a motion sensor (e.g., an accelerometer) embedded in the frame of the AR glasses to detect the head movement. In an alternative embodiment, head-mouse sub-unit 202 may detect the head movement based on images captured by a camera. In further embodiments, head-mouse sub-unit 202 can also track the movement of the user's eyes to control the mouse pointer. In this example, the user's eye movement (e.g., left and right or up and down) can be translated to the mouse pointer movement.

Hand-gesture sub-unit 204 can track and translate the hand gestures of the user into mouse pointer operations. In some embodiments, hand-gesture sub-unit 204 can detect the user's hand and recognize a number of predetermined hand gestures (such as closed fist, open fist, waving, etc.) based on live images. Each hand gesture can be mapped to a mouse operation. For example, a closed fist gesture may indicate confirming a selection (which can be equivalent to a mouse click), an open fist gesture may indicate closing a window, and a waving gesture may indicate turning the page. Hand-gesture sub-unit 204 can also track the movement of the hand (e.g., from left to right or from right to left) and move the mouse according to the hand movement.

Voice-control sub-unit 206 can facilitate the voice-based interactions between the user and the AR glasses. In some embodiments, voice-control sub-unit 206 can implement machine-learning techniques (e.g., Natural Language Processing (NLP) models) to translate the user's speech into operational commands. For example, after detecting the user's speech, voice-control sub-unit 206 can first use a speech recognition technique to process the speech into a written format (e.g., text) and then perform semantic analysis (e.g., by applying an NLP model) on the speech to obtain an operational command.

External-control sub-unit 206 can receive user inputs from various external user-control devices (e.g., an external mouse, a 6DOF joystick, a button, a touch sensor, etc.). The user can interact with an external device, which can then relay the user commands to the AR glasses.

In the example shown in FIG. 2, user-interaction unit 200 includes the aforementioned four sub-units. In practice, the AR glasses can use any mechanism to interact with the user, and user-interaction unit 200 can include any number of sub-units, including but not limited to those shown in FIG. 2.

Returning to FIG. 1, communication unit 110 can be responsible for facilitating communications between AR-glasses system 100 and the network (e.g., the cloud). Communication unit 110 can include a number of sub-units for establishing different types of communication channels. FIG. 3 illustrates an exemplary block diagram of the network unit, according to one embodiment of the instant application. In FIG. 3, communication unit 300 can include a Wi-Fi communication sub-unit 302, a cellular communication sub-unit 304, a Bluetooth communication sub-unit 306, and an IoT communication device 308.

Wi-Fi communication sub-unit 302 can be responsible for establishing a wireless communication channel based on various Wi-Fi protocols, such as the IEEE 802.11 standard. For example, Wi-Fi communication sub-unit 302 can include a radio that can communicate with a nearby Wi-Fi access point or hotspot. Cellular communication sub-unit 304 can establish a wireless communication channel based on various cellular mobile network standards, such as long-term evolution (LTE), 4G, 5G, etc. In one example, cellular communication sub-unit 304 can include a cellular modem to couple the AR glasses to a cellular network. Note that both the Wi-Fi communication sub-unit 302 and the cellular communication sub-unit 304 can allow the AR glasses to communicate with the cloud. This cloud networking capability allows the AR glasses to offload some computing (especially those requiring lots of computational resources) to the cloud while performing other computing locally. In one example, instead of performing the iris-recognition task locally by onboard processors, the AR glasses can use Wi-Fi communication sub-unit 302 or cellular communication sub-unit 304 to upload iris images or iris feature vectors extracted from the iris images to the cloud.

In addition to communicating with the cloud, the AR glasses can also communicate with a nearby device via Bluetooth communication sub-unit 306 or Internet of Things (IOT) communication sub-unit 308. Bluetooth communication sub-unit 306 can include a Bluetooth transmitter and a Bluetooth receiver for interacting with other Bluetooth-enabled devices, such as a smartphone, ear pods, or various access-control devices (e.g., smart locks). For example, when the AR glasses are used for authenticating a user requesting physical access to a secure location equipped with a Bluetooth-enabled smart lock, Bluetooth communication sub-unit 306 can communicate the user-authentication result generated by the AR glasses to the smart lock. In some embodiments, the user-authentication result can be a unique user ID mapped to the iris images or the iris-feature vector extracted from the iris images. Alternatively, the AR glasses may communicate the user-authentication result to a smartphone carried by the user, and an application running on the smartphone can provide an access code to the user or communicate with the smart lock. In one example, the application running on the smartphone may be a payment application. The user-authentication result sent from the AR glasses to the smartphone can facilitate secure payment. In another example, the nearby device can be a point-of-sale (POS) terminal, and the user-authentication result (which can include the unique user ID) can be sent from the AR glasses to the POS terminal to facilitate secure transactions. More specifically, the POS terminal can identify a financial account associated with the user ID to complete the transaction. IoT communication sub-unit 308 can allow AR glasses to communicate with IoT devices according to various IoT communication standards (e.g., Zigbee).

Returning to FIG. 1, localization unit 112 can be responsible for determining the near-field environment of the user. In one embodiment, localization unit 112 can apply a simultaneous localization and mapping (SLAM) technique to determine its location and the surrounding environment. For example, localization unit 112 can use a 3D scanning technique (e.g., through a laser scanner or an infrared matrix scanner) to map out the terrain surrounding the user. This location information can be used by the AR glasses to recognize and track objects in the environment and to accurately map the user's near-field environment. The location information can also be used to generate information about the user's surroundings (such as recognizing doors or locks) and superimpose such information on the real-world objects in the user's view.

The location information can also be used to place virtual objects (e.g., a virtual keypad for the user to enter an access code) in appropriate locations within the user's view to create a mixed reality (MR), in which the user can interact with both the physical world and the virtual world.

VR unit 114 can be responsible for generating virtual objects and determining the location for placing a virtual object in the real-world scene. Depending on the use scenario, VR unit 114 can generate different types of virtual objects. For example, VR unit 114 can render images comprising virtual objects to be displayed on the see-through display. Some virtual objects can include information (e.g., annotations) about the user's environment. For example, if the user is trying to gain physical access through a locked door, the door can be highlighted in the user's view. Some virtual objects can include computer-generated human characters or objects (e.g., a virtual assistant, a virtual keypad for entering an access code, etc.). VR unit 114 can use the location information provided by localization unit 112 to place the virtual objects at appropriate locations within the user's view. VR unit 114 can also facilitate the interactions between the user and the virtual objects. In one example, the user can manipulate virtual objects using hand gestures or head movements.

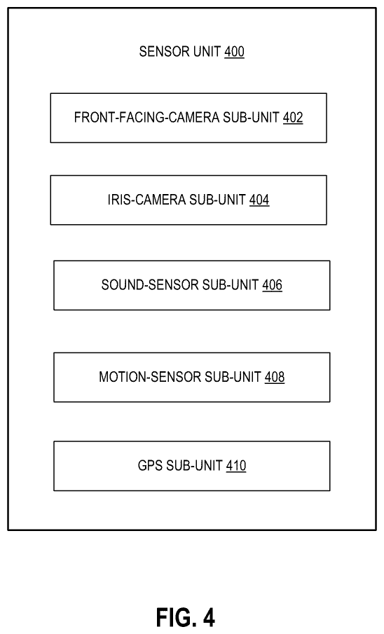

Sensor unit 116 can include different types of sensors that facilitate the various operations of the AR glasses. FIG. 4 illustrates an exemplary block diagram of the sensor unit, according to one embodiment of the instant application. In this example, sensor unit 400 can include a front-facing-camera sub-unit 402, an iris-camera sub-unit 404, a sound-sensor sub-unit 406, a motion-sensor sub-unit 408, and a Global Positioning System (GPS) unit 410.

Front-facing-camera sub-unit 402 can include one or more front-facing cameras that can capture images of the environment while the user is wearing the AR glasses. Such images can be used to obtain environmental information as well as certain user information. For example, the front-facing cameras can capture images of the user's hand to allow for hand-gesture-based control. Moreover, images captured by the front-facing cameras can be streamed in real-time to allow the user to live stream engaged activity to online viewers. In some embodiments, front-facing-camera sub-unit 402 can also include one or more time-of-flight (ToF) cameras that can be used to measure the distances of objects in the surrounding environment.

Iris-camera sub-unit 404 can include one or more rear-facing cameras that can be used to capture images of the user's iris. The rear-facing cameras can be mounted at various locations on the frame of the AR glasses. In one embodiment, iris-camera sub-unit 404 can include a single rear-facing camera that is mounted at the bottom of the rim of the left or right lens of the AR glasses, capturing images of the user's iris from a location below the user's eye. The camera can be located at the center of the lens rim or off the center. In a different embodiment, the single rear-facing camera can be mounted at the top of a lens rim, capturing images of the user's iris from a location above the user's eye. In some embodiments, multiple (e.g., two) rear-facing cameras can be mounted on the frame of the AR glasses. For example, each lens rim can be embedded or attached with a rear-facing camera, either at the bottom or top of the rim, capturing images of both eyes. In another example, multiple cameras can be mounted on the same lens rim to simultaneously capture multiple images of one eye from different viewing angles. The multiple images can be merged (e.g., stitched) to reduce the effect of occlusion (e.g., caused by eyelashes) and uneven lighting.

In addition to the front-and rear-facing cameras, the AR glasses may also include cameras facing the side to collect additional information surrounding the user. The front-, rear-, and side-facing cameras can include complementary metal-oxide semiconductor (CMOS) sensors. The resolution of the cameras can be 0.5 megapixels or above to allow for accurate iris-recognition operation.

Sound-sensor sub-unit 406 can include one or more sound sensors for detecting sound signals (e.g., the user's voice). Motion-sensor sub-unit 408 can include a number of sensors used to measure motion, such as an accelerometer, a gyroscope, a magnetometer, etc. In some embodiments, motion-sensor sub-unit 408 can be used to measure or track the user's head movement. GPS unit 410 can receive GPS signals to track the user's geographic location. In addition to the sensors shown in FIG. 4, sensor unit 400 can also include other types of sensors, such as a gravimeter, a geomagnetic sensor, a hexagonal gyroscope, an anemometer, a thermometer, a barometer, etc.

Returning to FIG. 1, power unit 118 can be responsible for providing power to the various units within AR-glasses system 100. In some embodiments, power unit 116 can include a built-in battery and a charging port. In one embodiment, the built-in battery can be a high-density lithium-ion battery with a capacity of greater than 100 mAh. In a further embodiment, the capacity of the battery can be 5000 mAh. The high-capacity battery and the low energy consumption of the various units in the AR glasses can ensure that the AR glasses can operate continuously for a prolonged period (e.g., three or more hours). The charging port can support fast charging. In one embodiment, the charging port can include contact points to allow the battery to be charged when placed in a case. In an alternative embodiment, the charging port can include a wireless charging interface. Power unit 116 can also include an interface for coupling to an external battery, such as a magnetic battery.

### The Appearance

The appearance of the AR glasses may be similar to that of regular glasses or sunglasses. Like a pair of glasses or sunglasses, a pair of AR glasses can include a frame and a pair of lenses. The lenses can be made of glass or plastic and can include a geometric waveguide display or a holographic waveguide display. The frame can be made of acrylonitrile butadiene styrene (ABS) resin or an alloy comprising polycarbonate (PC) and ABS. The electronic components (e.g., the processing, storage, and network units shown in FIG. 1) can be embedded inside the frame. Because the electronic components are lightweight and compact in size, the proposed AR glasses can be lightweight and compact. In some embodiments, the total weight of the AR glasses can be less than 75 grams.

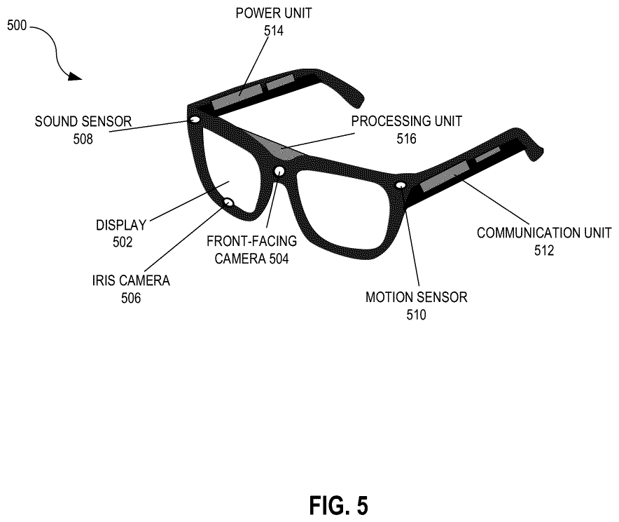

FIG. 5 illustrates an exemplary pair of AR glasses, according to one embodiment of the instant application. FIG. 5 shows that the right lens of AR glasses 500 can be used as a display (e.g., display 502). It is also possible that both lenses of AR glasses 500 can function as see-through displays. FIG. 5 also shows that the frame of AR glasses 500, including the rims surrounding the lenses, can be embedded with a number of sensors.

In the example shown in FIG. 5, a front-facing camera 504 can be embedded in the bridge between the two lenses. Front-facing camera 504 can capture images of the world scene in front of the user wearing AR glasses 500, thus allowing the recording or streaming of scenes and activities from the user's viewpoint. Amid privacy concerns, front-facing camera 504 can be equipped with a lens cover that covers front-facing camera 504 when the user is not recording or streaming. In one embodiment, front-facing camera 504 can also include an LED indicator that flashes when the camera is in operation to notify surrounding people that recording is taking place.

FIG. 5 also shows an iris camera 506 embedded in the lower rim of the right lens of AR glasses 500. When a user is wearing AR glasses 500, iris camera 506 can capture images of the user's right eye. Because iris camera 506 is embedded in the lower rim, it has a low viewing angle. In some embodiments, iris camera 506 can be turned on automatically once the user puts on AR glasses 500 and can capture images of the user's eye continuously or intermittently. In alternative embodiments, iris camera 506 can be turned on responsive to the user's command, which can be a voice command, a hand gesture, a head movement, a button pushing, etc. Although only one iris camera is shown in FIG. 5, in practice, multiple iris cameras can be embedded in the frame of AR glasses 500. For example, another iris camera can be embedded in the rim of the left lens. Note that the left and right directions mentioned here are with respect to the user wearing AR glasses 500. In other embodiments, an iris camera can be embedded in the top or side of the lens rim. In addition to embedding an iris camera inside the frame of AR glasses 500, it is also possible to attach an iris camera (e.g., via connection wires or cables) to the frame of AR glasses 500. In one example, the iris camera can be unpluggable, thus allowing the removal of the iris camera if the user does not want iris data to be collected.

Additional sensors, such as a sound sensor 508 and a motion sensor 510 can also be embedded in the rim of the lenses. The temples or arms of the frame of AR glasses 500 can include regions for embedding various electronic components, such as a communication unit 512 and a power unit 514. In some embodiments, the upper rims of AR glasses 516 can be slightly thicker (e.g., with a ledge for a snug fit with the user's forehead) to provide room for embedding components with a slightly larger form factor, such as a processing unit 516. Note that the placement of the different components shown in FIG. 5 is exemplary; depending on the design, different arrangements of the components can also be possible.

### The User-Authentication System

The disclosed AR glasses can support many different types of applications. In some embodiments, the embedded iris camera(s) can make it possible for the AR glasses to support iris-recognition-based user authentication applications. More specifically, iris-recognition-based user authentication can provide a highly secure and simplified means for the user to gain access to restricted resources. Compared with other biometric user-authentication techniques like fingerprinting or retinal scanning, iris-recognition-based user authentication can be simpler in implementation, because it does not require the user to physically contact the equipment performing the authentication. Moreover, iris recognition can be more accurate than facial recognition.

In one example, the restricted resource can be the AR glasses itself. A user wearing the AR glasses needs to be authenticated before he or she can access the many features provided by the AR glasses. In a different example, the restricted resource can be an electronic resource (e.g., a website, an application, or another computing device) or a physical location. The AR glasses can communicate the user-authentication result to the controller of the restricted resource, which can then grant or deny access based on the authentication result. The AR glasses can also display the user-authentication result to the user using the see-through display.

To perform iris-recognition-based user authentication, various units and subunits on the AR glasses (as shown in FIGS. 1-4) may be needed. Iris-camera sub-unit 404 can be used to capture iris images. Processing unit 102 can include various processors, such as processors for performing image processing and processors for performing machine learning. Storage unit 104 can store instructions that can be executed by the processors in processing unit 102, causing the processors to perform the various tasks associated with iris-recognition-based user authentication, such as image-processing tasks and machine-learning tasks. Communication unit 110 can communicate the user-authentication result to other devices, such as a controller device of a restricted resource. These units and subunits can together form an authentication system on the AR glasses that can be used to authenticate a user wearing the AR glasses.

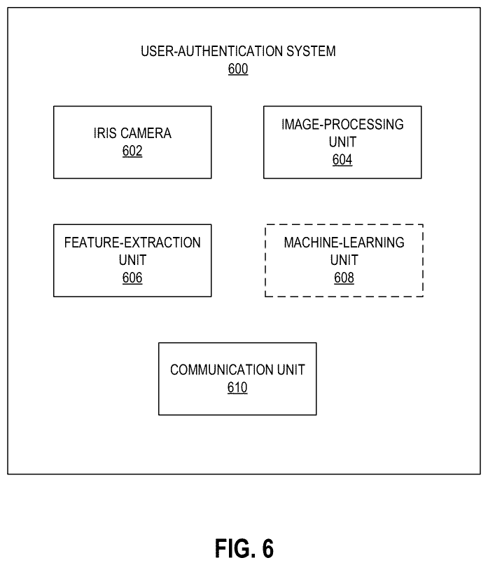

FIG. 6 illustrates an exemplary user-authentication system on a pair of AR glasses, according to one aspect of the instant application. In FIG. 6, a user-authentication system 600 can include an iris camera 602, an image-processing unit 604, a feature-extraction unit 606, an optional machine-learning unit 608, and a communication unit 610. These units can be implemented using hardware, software, or a combination thereof.

Iris camera 602 can capture images of the user's eye, including the iris. As discussed previously, iris camera 602 can be a miniature camera embedded in the frame of the AR glasses. There is no limitation on the embedding location of iris camera 602 as long as it can have a clear view of the user's eye. In some embodiments, user-authentication system 600 can include multiple cameras embedded at different locations of the frame of the AR glasses. The multiple cameras can capture images of the user's eye or eyes from different viewing angles.

The captured images of the user's eye or eyes cannot be directly used for iris recognition. Image-processing unit 604, which can include one or more graphic processing units (GPUs), can perform various image-processing operations on the eye images. For example, an eye image typically can include other portions of the eye, such as the eyelid and eyelashes, which do not contribute to iris recognition, and image-processing unit 604 can perform image segmentation to distinguish the iris from the background. In one embodiment, image-processing unit 604 can use various object-detection techniques to locate the boundaries of the pupil and the iris. A circular iris region can then be segmented from the eye image. In addition, image-processing unit 604 can perform an iris-normalization operation to map the annular iris region to a dimensionless pseudo-polar coordinate system. The normalization process can result in a rectangular structure that can be used to compensate for differences in scale and variation in pupil size. Other standard image-processing techniques, such as filtering and white balancing, can also be used to improve the quality of the captured eye images.

Feature-extraction unit 606 can extract iris features from the processed iris images. In one example, the iris features may be extracted directly from the iris portion of a captured eye image. In another example, the iris features can be extracted from the normalized iris image. Features extracted from the iris image can form a high-dimensional feature vector, which can be referred to as an iris-feature vector.

Optional machine-learning unit 608 can implement a pre-trained machine-learning model (e.g., a deep-learning neural network) to perform iris recognition. The model may use iris images or iris-feature vectors as input and may output a user-authentication result. For user verification purposes, the machine-learning model can be trained using iris images of the to-be-verified user, and the model can output a prediction about the verification result (e.g., true or false). For example, the model can be trained using ten or more iris images of the user. For user identification purposes, the machine-learning model can be trained using a large data set that includes iris images of many users. Each user may have ten or more iris images in the dataset. Each user may be assigned a user identification (ID), and the model can output a predicated user ID based on the input of iris images or iris feature vectors. In some embodiments, the machine-learning model can be trained continuously while the user is wearing the AR glasses to ensure that the model can make accurate predictions under different conditions, such as different lighting conditions. More specifically, while a user is wearing the AR glasses, iris camera 602 can continuously or intermittently capture the user's iris images under different lighting and eye movement conditions. These captured images can be used as labeled samples to update the parameters of the machine-learning model.

Communication unit 610 can be responsible for communicating with other computing devices, including nearby devices (e.g., smartphones or IoT devices) and remote cloud servers. In some embodiments, the user verification or identification output of machine-learning unit 608 can be communicated to a nearby computing device, such as an access controller of a restricted resource, thus allowing the user to gain access to the restricted resource. In one example, the access controller can be an access-control application running on the user's smartphone, and communication unit 610 can send the output of machine-learning unit 608 to the smartphone, which executes the access-control application to allow the user to gain access to the restricted resource. In another example, the nearby computing device can be a POS terminal. The smart glasses can send the user identification output (e.g., a user ID) to the POS terminal, thus allowing the POS terminal to identify a financial account (e.g., a bank account or a credit card) associated with the user ID.

Due to the resource constraint, the AR glasses may not be equipped with a machine-learning unit that can perform the iris-recognition task. In such cases, communication unit 610 can send the output of feature-extraction unit 606, which can include the iris-feature vector, to a remote cloud server. For security purposes, the iris-feature vector can be encrypted (e.g., by an encryption unit not shown in FIG. 6) before it is sent to the remote cloud server. The remote cloud server can use a pre-trained machine learning model to make predictions about the user's identity and then send the prediction result to the access controller of the restricted resource. In one example, the restricted resource is the AR glasses, and the remote cloud server can send the user verification result to communication unit 610 to facilitate the user accessing resources (e.g., the see-through display) on the AR glasses.

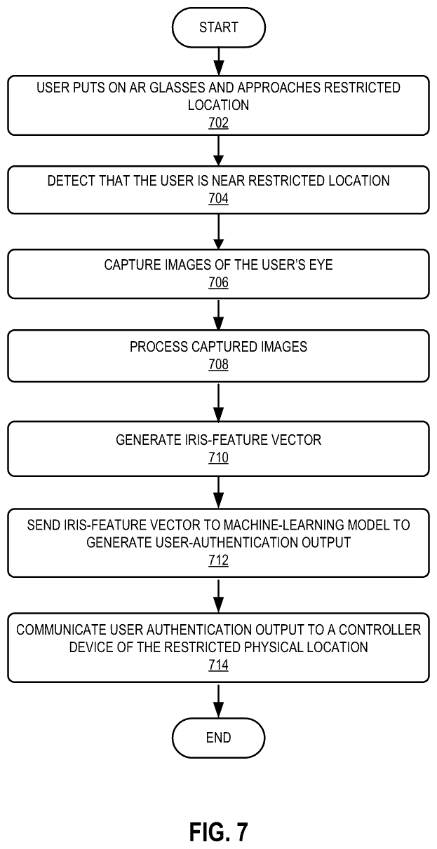

FIG. 7 presents a flowchart illustrating an exemplary user-authentication operation performed by a pair of AR glasses, according to one embodiment of the instant application. In this example, the pair of AR glasses can be used to facilitate the user in accessing a restricted physical location (e.g., a bank vault). During operation, a user puts on the AR glasses and approaches the restricted physical location (operation 702). Note that the AR glasses can belong to the user or can be provided to the user by the administrator or manager of the restricted location. The AR glasses can detect, via GPS and 3D-scanning techniques, that the user is near the restricted location (operation 704). For example, the AR glasses can detect that the user is standing by the door of the bank vault, waiting for the door to open.

An iris camera embedded in the frame of the AR glasses can capture images of the user's eye (operation 706). In some embodiments, the user may need to issue a command (e.g., by waving a hand gesture or nodding the head) to activate the iris camera. Alternatively, the iris camera can be activated responsive to the AR glasses detecting that the user is standing near the entrance of the restricted location. In some embodiments, the AR glasses may instruct the user (e.g., via the see-through display) to perform a series of predetermined eye movements (e.g., look up and down or from side to side) while the iris camera captures multiple images.

The captured images can be processed (e.g., by image-processing unit 604 shown in FIG. 6) (operation 708). In some embodiments, an iris region in each image can be detected, segmented, and normalized. Subsequently, an iris-feature vector can be generated (e.g., by feature-extraction unit 606 shown in FIG. 6) based on the processed iris images (operation 710). The iris-feature vector can be sent to a machine-learning model (e.g., a deep-learning neural network) to generate a user-authentication output (operation 712). In some embodiments, each authorized user of the restricted resource can be assigned a unique user ID, and the machine-learning model can output prediction regarding the user's identity (e.g., the user ID). If the machine-learning model cannot find a user ID corresponding to the iris-feature vector, it can generate an output to indicate that no match is found.

The output of the machine-learning model can be sent (e.g., via communication unit 610 shown in FIG. 6) to a controller device of the restricted physical location (operation 714), which can then allow the user to gain access to the restricted physical location. For example, the user-authentication output can be sent to a smart lock on the door of the bank vault, causing the smart lock to unlock.

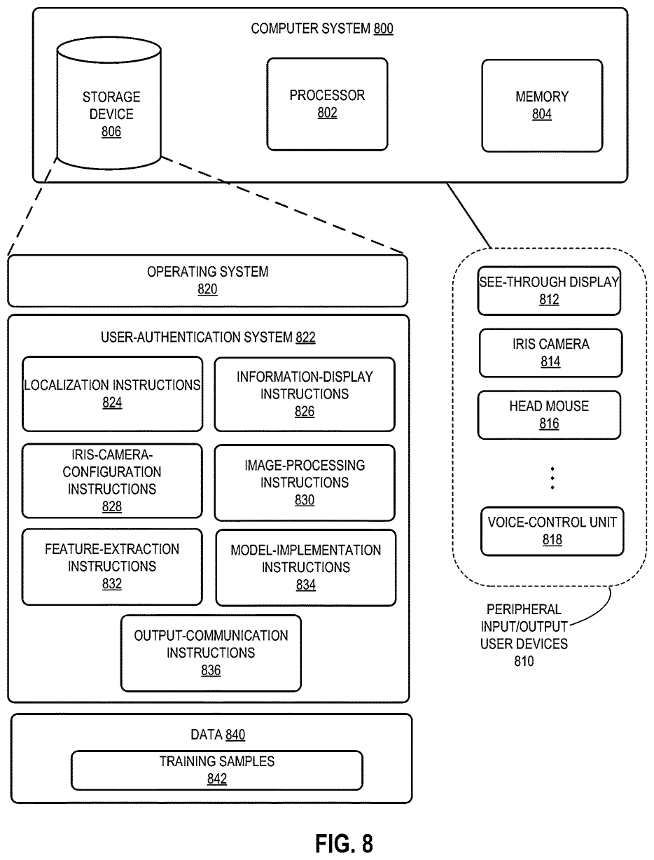

FIG. 8 illustrates an exemplary computer system that facilitates the user-authentication operation of the AR glasses, according to one embodiment of the instant application. Computer system 800 includes a processor 802, a memory 804, and a storage device 806. Furthermore, computer system 800 can be coupled to peripheral input/output (I/O) user devices 810, e.g., a see-through display 812, an iris camera 814, a head mouse 816, and a voice-control unit 818. Storage device 806 can store an operating system 820, a user-authentication system 822, and data 840.

User-authentication system 822 can include instructions, which when executed by computer system 800, can cause computer system 800 or processor 802 to perform methods and/or processes described in this disclosure. Specifically, user-authentication system 822 can include instructions for determining the user's location (localization instructions 824), instructions for obtaining and displaying information associated with the location and the surrounding environment (information-display instructions 826), instructions for configuring the iris camera to capture iris images (iris-camera-configuration instructions 828), instructions for processing the iris images (image-processing instructions 830), instructions for extracting features from processed iris images (feature-extraction instructions 832), instructions for implementing a machine-learning model to perform iris-recognition tasks (model-implementation instructions 834), and instructions for communicating the user-authentication output generated by the machine-learning model (output-communication instructions 836). Data 840 can include model training samples 842.

This disclosure describes lightweight and compact AR glasses that can be used to authenticate a user wearing the AR glasses. The AR glasses can have an appearance that is similar to regular glasses or sunglasses. One or both lenses of the AR glasses can function as a see-through display with 360° unlimited virtual window extension. The AR glasses can use a number of ways to interact with the user, including head/eye tracking, hand gesture tracking, voice recognition, and the use of external controllers. The AR glasses can include one or more network interfaces (e.g., Wi-Fi, cellular, Bluetooth, and IoT) for communicating with nearby computing devices and remote servers. The AR glasses can also include a number of sensors (e.g., cameras, sound sensors, motion sensors, GPS sensors, etc.) for obtaining information associated with the user and the environment. More specifically, the AR glasses can include at least one rear-view camera embedded in or attached to the rim of a lens. The rear-view camera can capture images of the user's eye, including the iris region. The AR glasses can include an image-processing unit that can process the iris or eye images to detect and segment the iris region. The image-processing unit can also normalize the images to compensate for differences in scale and variation in pupil size. The AR glasses can include a feature-extraction unit that can extract features from the processed iris images to generate an iris-feature vector. The iris-feature vector can be inputted into a pre-trained deep-learning neural network that can output a prediction regarding the user's identity. The deep-learning neural network can be implemented locally by the AR glasses or remotely by a cloud server. The prediction output of the deep-learning neural network can be sent to an access controller of a restricted resource to facilitate the use in gaining access to the restricted resource.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices, solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the optimized parameters from the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A pair of augmented reality (AR) glasses, comprising:
a pair of lenses, wherein at least a portion of a lens of the AR glasses functions as a see-through display;
a frame comprising rims surrounding the lenses; and
a rear-facing camera embedded in a rim, wherein the rear-facing camera is configured to capture images of a corresponding eye of a user while the user is wearing the AR glasses; and
a user-authentication system to authenticate the user based on the captured eye images;
wherein a result of the user authentication is displayed on the see-through display.

2. The AR glasses of claim 1, wherein the rear-facing camera is embedded at a bottom portion of the rim.

3. The AR glasses of claim 1, wherein the rear-facing camera is embedded at a top portion of the rim.

4. The AR glasses of claim 1, further comprising a second rear-facing camera embedded in a second rim.

5. The AR glasses of claim 1, wherein the user-authentication system further comprises:
an image-processing unit to process the captured images; and
a feature-extraction unit to extract iris features from the captured images.

6. The AR glasses of claim 5, wherein, while processing a captured image, the image-processing unit is to detect and segment an iris portion within the captured image.

7. The AR glasses of claim 5, wherein the user-authentication system further comprises a machine-learning unit configured to generate the user-authentication result by using the extracted iris features as input of a pre-trained machine-learning model.

8. The AR glasses of claim 7, further comprising a communication unit configured to communicate the user-authentication result to a controller of a restricted resource to facilitate the user in accessing the restricted resource.

9. The AR glasses of claim 8, wherein the communication unit comprises one or more of:
a Wi-Fi communication sub-unit;
a cellular communication sub-unit;
a Bluetooth communication sub-unit; and
an Internet of Things (IOT) communication sub-unit.

10. The AR glasses of claim 7, wherein the rear-facing camera is configured to continuously or intermittently capture images of the corresponding eye of the user subsequent to authenticating the user, the captured images to be used in further training of the machine-learning model.

11. A method for authenticating a user, comprising:
capturing, by a rear-facing camera embedded in a pair of augmented reality (AR) glasses worn by the user, images of an eye of the user;
processing the captured images;
extracting iris features from the processed images; and
inputting the extracted iris features to a pre-trained machine-learning model to generate a user-authentication output.

12. The method of claim 11, wherein the AR glasses comprise a pair of lenses and rims surrounding the lenses, and wherein at least a portion of a lens functions as a see-through display.

13. The method of claim 12, wherein the rear-facing camera is embedded at a top or bottom portion of a rim of the AR glasses.

14. The method of claim 11, wherein processing a captured image comprises detecting and segmenting an iris portion within the captured image.

15. The method of claim 11, further comprising communicating the user-authentication output to a controller of a restricted resource to facilitate the user in accessing the restricted resource.

16. The method of claim 15, wherein the user-authentication output is communicated via:
a Wi-Fi communication interface;
a cellular communication interface;
a Bluetooth communication interface; or
an Internet of Things (IOT) communication interface.

17. The method of claim 11, further comprising communicating the extracted iris features to a remote cloud server that uses the pre-trained machine-learning model to generate the user-authentication output.

18. The method of claim 17, further comprising encrypting the extracted iris features.

19. A non-transitory computer-readable storage medium storing instructions that when executed by a computer cause the computer to perform a method for authenticating a user, the method comprising:
configuring a rear-facing camera embedded in a pair of augmented reality (AR) glasses worn by the user to capture images of an eye of the user;
processing the captured images;
extracting iris features from the processed images; and
inputting the extracted iris features to a pre-trained machine-learning model to generate a user-authentication output.

20. The non-transitory computer-readable storage medium of claim 19, wherein the method further comprises communicating the user-authentication output to a controller of a restricted resource to facilitate the user in accessing the restricted resource.
